(19) United States
(12) Patent Application Publication
(10) Pub. No.: US 2018/0237577 A1
(43) Pub. Date: Aug. 23, 2018

(54) USE OF POLYETHER CARBONATE POLYOLS FOR PRODUCING POLYURETHANE FOAMS WITH STABLE COLOUR

(71) Applicant: Covestro Deutschland AG, Leverkusen (DE)

(72) Inventors: Lutz Brassat, Leverkusen (DE); Ralf Pohlig, Leichlingen (DE); Hans-Georg Pirkl, Leverkusen (DE)

(21) Appl. No.: 15/552,846

(22) PCT Filed: Feb. 25, 2016
(86) PCT No.: PCT/EP2016/054014

§ 371 Date: Aug. 23, 2017

(30) Foreign Application Priority Data
Feb. 27, 2015 (EP) 15157034.8

(51) Int. Cl. C08G 18/44; C08J 9/00; C08J 9/12; C08G 18/48; C08G 18/24; C08G 18/18; C08G 18/16; C08G 18/76; C08G 18/40

(52) U.S. Cl. CPC C08G 18/44; C08J 9/0038; C08J 9/0066; C08J 9/0023; C08J 9/125; C08G 18/4829; C08G 2101/0008; C08G 18/244; C08G 18/1833; C08G 18/165; C08G 18/7621; C08G 18/4018; C08G 18/4816

(57) ABSTRACT

The present invention relates to the use of a component A for the production of colour-stable polyurethane foams, containing
A1≥50 to ≤100 weight parts of at least one polyether carbonate polyol with a hydroxyl number from ≥20 mg KOH/g to ≤300 mg KOH/g according to DIN 53240,
A2≤50 to ≥0 weight parts of at least one polyether polyol with a hydroxyl number from ≥20 mg KOH/g to ≤250 mg KOH/g according to DIN 53240, wherein the polyether polyol is free from carbonate units,
A3 0.5 to 25 weight parts, based on the sum of the weight parts of components A1 and A2, water and/or physical propellants,
A4 0 to 10 weight parts, based on the sum of the weight parts of components A1 and A2, at least one antioxidant,
A5 0 to 10 weight parts, based on the sum of the weight parts of components A1 and A2, adjuvants and additives,
   wherein all weight part data of the components A1 to A5 are scaled such that the sum of the weight parts A1+A2 is 100 in the composition. The invention also relates to the use of a subsequently produced colour-stable polyurethane foam for the production of furniture upholstery, textile inlays, mattresses, car seats, headrests, armrests, sponges, foam foils for use in automotive parts such as roof liners, door claddings, seat covers and construction components and the use of a polyol component comprising ≥50 to ≤100 weight % based on the polyol component of at least one polyether carbonate polyol A1 with a hydroxyl number according to DIN 53240 from ≥20 mg KOH/g to ≤300 mg KOH/g for the production of colour-stable polyurethane foams.

### CROSS-REFERENCE TO RELATED APPLICATIONS

This Application is a National Phase Application of PCT/EP2016/054014, filed Feb. 25, 2016, which claims priority to European Application No. 15157034.8 filed Feb. 27, 2015, each of which is being incorporated herein by reference.

### FIELD

The present invention relates to the use of a polyol component containing polyether carbonate polyol for the production of colour-stable polyurethane foams.

### BACKGROUND

As is known from the state of the art, polyurethane foams are primarily produced from a polyol component and a polyisocyanate component. It is known that mostly polyether polyols are used as polyol component. Different designs of such polyols with regard to their hydroxyl number or their OH functionality and molecular weight are commercially easily available.

With regard to the polyurethane foams produced from polyether polyols, the fact that the produced foams are subject to signs of ageing which are optically visible in the form of a noticeable colour change after only a few months can be found to be disadvantageous in certain applications. Additionally, the colour change on existing edges is much more pronounced in the case of construction components formed from polyurethane foams so that the colour change is even more visible.

UV stable polyurethane foams are known from US 2005/065225 A1. For this purpose, polyisocyanates are reacted with polycarbonate polyols. Optionally, a polyether polyol can be used as an additional polyol component in order to improve the flexibility of the foams. The polycarbonate polyols are obtained by transesterification of carbonate esters and therefore constitute a comparatively expensive raw material.

### SUMMARY

The object of the present invention is to provide a possibility to produce polyurethane foams with a better colour stability. For this purpose, it is desired to make available colour-stable polyurethane hard foams as well as colour-stable polyurethane soft foams.

This object is achieved by the use of a component A for the production of colour-stable polyurethane foams, containing
A1≥50 to ≤100 weight parts of at least one polyether carbonate polyol with a hydroxyl number from ≥20 mg KOH/g to ≤300 mg KOH/g according to DIN 53240,
A2≤50 to ≥0 weight parts of at least one polyether polyol with a hydroxyl number from ≥20 mg KOH/g to ≤250 mg KOH/g according to DIN 53240, wherein the polyether polyol is free from carbonate units,
A3 0.5 to 25 weight parts, based on the sum of the weight parts of components A1 and A2, water and/or physical propellants,
A4 0 to 10 weight parts, based on the sum of the weight parts of components A1 and A2, at least one antioxidant,
A5 0 to 10 weight parts, based on the sum of the weight parts of components A1 and A2, adjuvants and additives,
   wherein all weight part data of the components A1 to A5 are scaled such that the sum of the weight parts A1+A2 is 100 in the composition.

The invention is based on the discovery that with the use of 50 to 100 weight parts of a polyether carbonate polyol with a hydroxyl number according to DIN 53240 from ≥20 mg KOH/g to ≤300 mg KOH/g, a visible improvement of the colour stability of polyurethane foams produced thereof can be obtained compared to foams which exclusively contain polyether polyols without carbonate units. Apart from the improved colour stability, the polyurethane foams produced according to the invention also contain relatively high amounts of carbon dioxide, which is advantageous with regard to the environment.

Thus, a further object of the present invention is the use of a polyol component comprising ≥50 to ≤100 weight % based on the polyol component of at least one polyether carbonate polyol A1 with a hydroxyl number according DIN 53240 from ≥20 mg KOH/g to ≤300 mg KOH/g for the production of colour-stable polyurethane foams. In other words, the polyol component for the production of the polyurethane foams may exclusively consist of the polyether carbonate polyol A1 mentioned above, wherein no other organic polyols than the ones which fall under the definition of the polyether carbonate polyol A1 are used.

Furthermore, it is possible to adapt the hardness of the produced foams to the respective requirements profile by using polyether carbonate polyols with a hydroxyl number according to DIN 53240 in the range of ≥20 mg KOH/g to ≤300 mg KOH/g according to the invention. Thus, polyurethane hard foams as well as polyurethane soft foams can be produced. By using polyether carbonate polyols with a hydroxyl number according to DIN 53240 from ≥150 mg KOH/g to ≤300 mg KOH/g, it is even possible to produce polyurethane soft foams with viscoelastic properties.

### BRIEF DESCRIPTION OF THE DRAWINGS

FIG. 1 is a graph which illustrates the differences in colour of the foam samples V1 and V3 on the various surfaces of each foam body and in the center of each foam body.

FIG. 2 is a chart which illustrates the differences in colour of the foam samples V2 and V4 on the various surfaces of each foam body and in the center of each foam body.

### DETAILED DESCRIPTION

A viscoelastic polyurethane foam or polyurethane soft foam is considered to be a foam which has a low ball rebound elasticity according to DIN EN ISO 8307:2007. According to that, a ball is dropped on a foam test body from a defined height and the height in which the ball rebounds against the fall direction is measured. The rebound height is put in a percentage relation to the fall height. A low percentage value indicates a low rebound resilience. Ideally, the ball does not measurably rebound after its impact, which means that the ball rebound elasticity is 0%. In an advantageous embodiment of the method according to the invention, a viscoelastic polyurethane foam or polyurethane soft foam having a ball rebound elasticity according to DIN EN ISO 8307:2007 of 0% to 20%, in particular of 0% to 15%, preferably 0% to 10% or even 0% to 8% is obtained. Also preferred are polyurethane foams or polyurethane soft foams with a ball rebound elasticity according to DIN EN ISO 8307:2007 of 2% to 20%, in particular of 2% to 15%.

A colour-stable polyurethane foam shall in particular mean that the colour-stable polyurethane foam in the form of a rectangular or square sample body has, in the centre of at least one of its flat sides and after a storage time of 90 days at 20° C. and a relative humidity of 40%, a shift of the colour angle in the HSI model which is at least 5° less than the one of a reference polyurethane foam which is produced and stored in the same manner as the colour-stable polyurethane foam, wherein the only difference between the reference polyurethane foam and the colour-stable polyurethane foam is that instead of the polyether carbonate polyol A1, an essentially identical amount of a polyether polyol without carbonate units, but with essentially the same hydroxyl number according to DIN 53240 is used for the production of the former. The rectangular or square sample body should have no side edge which is shorter than 0.5 cm as the signs of ageing are greatest on the edges, which makes it more difficult to evaluate the colour change of the main surface. Preferably, the sample body of the colour-stable polyurethane foam has, in the centre of at least one of its flat sides, a shift of the colour angle in the HSI model which is at least 8° less than the one of the sample body of the reference polyurethane foam, in particular at least 10° or even 15° less. It is to be understood that the polyurethane foams should not contain any colourants or colour pigments for these measurements in order not to distort the measurement. All above-mentioned values concerning the shift of the colour angle refer to a storage in the dark and under the above-mentioned conditions. When exposed to daylight or UV light, the values can be higher.

Here, a “lower shift of the colour angle” shall generally mean a reduction of the colour angle from higher degree numbers to lower degree numbers which is less pronounced, i.e. for example from greenish colour tones (angle H=120°) to yellowish colour tones (angle H=60°).

The colour angle is determined such that the respective sample body is photographed lying on a white sheet of paper with the help of a digital camera (Sony DSC-R1), a white balance against the white sheet of paper is carried out and then the colour tone is determined as the colour angle from the HSI model and from the photograph with the help of an image evaluation software (AnalySIS). The colour shade is determined as colour angle H on the colour wheel (0°=red, 120°=green, 240°=blue) and specifies the dominant wavelength of the colour, with the exception of the area between violet-blue and red (240° and 360°) where it indicates a position on the purple line. This measurement is respectively carried out with a colour-stable polyurethane foam produced according to the invention following the above-mentioned ageing and a reference polyurethane foam aged in the same manner. The determined colour angles of the colour-stable polyurethane foam and the reference polyurethane foam are subtracted from one another and thus provide the shift of the colour angle which is at least 5° less according to the invention for the colour-stable polyurethane foam.

As explained above, the only difference between the colour-stable polyurethane foam produced according to the invention and the reference polyurethane foam is that an essentially identical amount of a polyether polyol without carbonate units, but with essentially the same hydroxyl number according to DIN 53240 instead of the polyether carbonate polyol A1 is used in the reference polyurethane foam. That means for example a polyether polyol with a hydroxyl number according to DIN 53240 of 150 mg/KOH instead of a polyether carbonate polyol A1 with a hydroxyl number according to DIN 53240 of 150 mg/KOH. Advantageously, ten identical samples each are measured and the mean value thereof is determined.

For the production of the polyurethane foams, the reaction components are reacted using the basically known one-step method, wherein often mechanical devices are used, e.g. as described in EP-A 355 000. Details of processing equipment which is also suitable according to the invention are described in the Kunststoff-Handbuch, Volume VII, edited by Vieweg and Hoechtlen, Carl-Hanser-Verlag, Munich 1993, e.g. on pages 139 to 265.

In a preferred embodiment of the use of the invention, component A is reacted with a component B containing
B di- and/or polyisocyanates,
   at an isocyanate index of 70 to 130, for the production of the colour-stable polyurethane foams.

The polyurethane foams produced with the method according to the invention can be prepared as mould or as block foams, preferably as block foams. Insofar, a further object of the present invention is the use of the colour-stable polyurethane foams according to the invention for the production of form parts as well as the form parts themselves.

A particularly preferred polyurethane foam or polyurethane soft foam which is obtainable by the method according to the invention is one for whose production a polyether carbonate polyol A1 having a hydroxyl number from >250 mg KOH/g to <300 mg KOH/g according to DIN 53240 is used. Apart from its good colour stability, such a polyurethane foam or polyurethane soft foam is characterised by particularly good viscoelastic characteristics, i.e. a particularly low ball rebound elasticity according to DIN EN ISO 8307:2007. The used polyether carbonate polyol A1 particularly has an average OH functionality of 2.3 to 3.5, in particular of 2.5 to 3.3, preferably of 2.7 to 3.1, 2.8 to 3.0 being particularly preferred.

The indefinite term “a(n)” generally means “at least one” in the sense of “one or more”. The skilled person will understand that, depending on the situation, not the indefinite article but the definite article “one” in the sense of “1” must be meant or the indefinite article “a(n)” also the definite article “one” (1) in one embodiment.

In the following, the components used in the method according to the invention will be described in more detail.

### Component A1

Component A1 comprises a polyether carbonate polyol with a hydroxyl number (OH number) from ≥20 mg KOH/g to ≤300 mg KOH/g, preferably from ≥24 mg KOH/g to ≤280 mg KOH/g, further preferred from ≥40 mg KOH/g to ≤280 mg KOH/g according to DIN 53240. Especially for the production of viscoelastic foams, it is preferred that the polyether carbonate polyol A1 has a hydroxyl number according to DIN 53240 of ≥150 mg KOH/g to ≤300 mg KOH/g, in particular of ≥180 mg KOH/g to ≤300 mg KOH/g, further preferred of >250 mg KOH/g to ≤280 mg KOH/g.

The aforementioned polyether carbonate polyols can for example be obtained by copolymerisation of ≥2 weight % to ≤30 weight % of carbon dioxide and ≥70 weight % to ≤98 weight % of one or more alkylene oxides in the presence of one or more H-functional starter molecules with an average functionality of ≥1 to ≤6, preferably of ≥1 and ≤4, ≥2 and ≤3 being particularly preferred. Preferably, ≥10 weight % to ≤27 weight % of carbon dioxide are used for copolymerisation, ≥15 weight % to ≤25 weight % being particularly preferred. “H-functional” in the sense of the invention shall mean a starter compound which has H atoms which are active towards alkoxylation. For example, trimethylol propane, glycerol and/or propylene glycol and/or sorbitol can be used as hydroxy functional starter molecule. The hydroxyl number can be determined according to DIN 53240.

Preferably, the copolymerisation of carbon dioxide and one or more alkylene oxides is in the presence of at least one multi metal cyanide catalyst or double metal cyanide catalyst (DMC catalyst).

Preferably, the polyether carbonate polyols used according to the invention also have ether groups between the carbonate groups, which is schematically shown in formula (I). In the scheme according to formula (I), R is an organic residue such as alkyl, alkylaryl or aryl, which may also contain heteroatoms such as O, S, Si, and so on, wherein E and F are integers. The polyether carbonate polyol shown in the scheme according to formula (I) shall only mean that blocks with the shown structure in the polyether carbonate polyol can be found again, but the sequence, number and length of the blocks may vary and is not restricted to the polyether carbonate polyol shown in formula (I). With regard to formula (I), this means that the e/f ratio is preferably 2:1 to 1:20, especially preferred from 1.5:1 to 1:10.

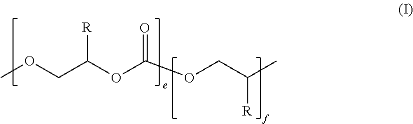

The proportion of incorporated CO₂ (“units derived from carbon dioxide) in a polyether carbonate polyol can be determined by the evaluation of characteristic signals in the ¹H-NMR spectrum. The following example illustrates the determination of the proportion of units derived from carbon dioxide in a CO₂/propyleneoxide-polyether carbonate polyol started on 1,8-octanediol.

The proportion of incorporated CO₂ in a polyether carbonate polyol as well as the relation of propylene carbonate to polyether carbonate polyol can be determined by ¹H-NMR (a used device is from the company Bruker, DPX 400, 400 MHz; pulse programme zg30, waiting period d1:10 s, 64 scans). Each sample is dissolved in deuterated chloroform. The relevant resonances in ¹H-NMR (based on TMS=0 ppm) are as follows:

Cyclic carbonate (which was formed as by-product) with a resonance at 4.5 ppm; carbonate, resulting from carbon dioxides incorporated in the polyether carbonate polyol with resonances at 5.1 to 4.8 ppm; non-abreacted propyleneoxide (PO) with a resonance at 2.4 ppm; polyether polyol (i.e. without incorporated carbon dioxide) with resonances at 1.2 to 1.0 ppm; 1.8 octanediol incorporated as starter molecule (if available) with a resonance at 1.6 to 1.52 ppm.

The molar content of the carbonate incorporated in the polymer in the reaction mixture is calculated as follows according to formula (II), wherein the following abbreviations are used:

F(4.5)=resonance area at 4.5 ppm for cyclic carbonate (corresponds to one H atom)
F(5.1-4.8)=resonance area at 5.1-4.8 ppm for polyether carbonate polyol and one H atom for cyclic carbonate.
F(2.4)=resonance area at 2.4 ppm for free, non-abreacted PO
F(1.2-1.0)=resonance area at 1.2-1.0 ppm for polyether polyol
F(1.6-1.52)=resonance area at 1.6 to 1.52 ppm for 1,8 octanediol (starter), if available.

Taking into account the relative intensities, the polymer-bound carbonate (“linear carbonate” LC) in the reaction mixture was converted into mol % according to the following formula (II):

$$LC = \frac{F ( 5 , 1 - 4 , 8 ) - F ( 4 , 5 )}{\begin{matrix}F ( 5 , 1 - 4 , 8 ) + F ( 2 , 4 ) + 0 , 33 * F ( 1 , 2 - 1 , 0 ) + \\ 0 , 25 * F ( 1 , 6 - 1 , 52 )\end{matrix}} * 100 \qquad ( II )$$

The weight proportion (in weight %) of the polymer-bound carbonate (LC′) in the reaction mixture was calculated according to formula (III):

$${LC}^{′} = \frac{[ F ( 5 , 1 - 4 , 8 ) - F ( 4 , 5 ) ] * 102}{N} * 100 \% \qquad ( III )$$

This results in the value for N (“denominator” N) according to formula (IV) as follows:

N=[F(5,1−4,8)−F(4,5)]*102+F(4,5)*102+F(2,4)*58+0,33*F(1,2−1,0)*58+0,25*F(1,6−1,52)*146 (IV)

The factor 102 results from the sum of the molar masses of CO₂ (molar mass 44 g/mol) and of propylene oxide (molar mass 58 g/mol), the factor 58 results from the molar mass of propylene oxide and the factor 146 results from the molar mass of the used starter 1,8-octanediol (if available).

The weight proportion (in weight %) of cyclic carbonate (CC′) in the reaction mixture was calculated according to formula (V):

$${CC}^{′} = \frac{F ( 4 , 5 ) * 102}{N} * 100 \% \qquad ( V )$$

wherein the value of N is calculated according to formula (IV).

In order to calculate the composition based on the polymer proportion (consisting of polyether polyol, which was produced from the starter and of propylene oxide during the activation steps under conditions free from CO₂, and polyether carbonate polyol produced from the starter, propylene oxide and carbon dioxide during the activation steps occurring in the presence of CO₂ and during copolymerisation) from the values of the composition of the reaction mixture, the non-polymer components of the reaction mixture (i.e. cyclic propylene carbonate and possibly available, non-reacted propylene oxide) were eliminated by calculation. The weight proportion of the carbonate repeat units in the polyether carbonate polyol was converted into a weight proportion of carbon dioxide using the factor F=44/(44+58). The indication of the CO₂ content in the polyether carbonate polyol is normalised to the proportion of the polyether carbonate polyol molecule which was formed during copolymerisation and possibly during the activation steps in the presence of CO₂ (e.g. the proportion of the polyether carbonate polyol molecule resulting from the starter (1,8-octanediol, if available) and from the reaction of the starter with epoxide which was added under CO₂-free conditions was not considered).

For example, the production of polyether carbonate polyols according to A1 comprises:

(α) the presentation of a H-functional starter substance or a mixture of at least two H-functional starter substances and optionally the removal of water and/or other readily volatile compounds by elevated temperature and/or reduced pressure (“drying”), wherein the DMC catalyst of the H-functional starter substance or the mixture of at least two H-functional starter substances is added before or after drying,
(β) a partial amount (based on the total amount of the alkenyl oxides used for activation and copolymerisation) of one or more alkenyl oxides is added to the mixture resulting from step (a) for activation, wherein this addition of a partial amount of alkenyl oxides can possibly occur in the presence of CO₂, and wherein then the temperature peak (“hotspot”) occurring due to the following exothermic chemical reaction and/or a pressure drop in the reactor are respectively awaited, and wherein step (β) for activation can also occur several times,
(γ) one or more of the alkenyl oxides and carbon dioxide are added to the mixture resulting from step (β), wherein the alkenyl oxides used in step (β) can be the same as or different from the alkenyl oxides used in step (γ).

Generally, alkenyl oxides (epoxides) with 2 to 4 carbon atoms can be used for the production of the polyether carbonate polyols A1. The alkenyl oxides with 2 to 24 carbon atoms are for example one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-penteneoxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrole oxide, methylstyrole oxide, pinene oxide, one or more times epoxy-enhanced fats as mono-, di- and triglycerides, epoxy-enhanced fat acids, C₁-C₂₄ esters of epoxy-enhanced fat acids, epichlorohydrin, glycidol, and derivates of the glycidol, such as methylglycidyl ethers, ethylglycidyl ethers, 2-ethylhexylglycidyl ethers, allylglycidyl ethers, glycidylmethacrylate and epoxy-functional alkoxy silanes such as 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preferably, ethylene oxide and/or propylene oxide and/or 1,2 butylene oxide are used as alkylene oxides, propylene oxide being particularly preferred.

In a preferred embodiment of the invention, the amount of ethylene oxide in the total amount of propylene oxide and ethylene oxide used is ≥0 and ≤90 weight %, preferably ≥0 and ≤50 weight % and particularly preferably free from ethylene oxide.

Compounds with H-atoms which are active for alkoxylation can be used as suitable H-functional starter substances. Groups with active H-atoms which are active for alkoxylation are for example —OH, —NH₂ (primary amines), —NH— (secondary amines), —SH and —CO₂H, —OH and —NH₂ being preferred, —OH being particularly preferred. For example, one or more compounds selected from the group consisting of water, monovalent or polyvalent alcohols, polyvalent amines, polyvalent thiols, amino alcohols, thio alcohols, hydroxy esters, polyether polyols, polyester polyols, polyesterether polyols, polyether carbonate polyols, polycarbonate polyols, polycarbonates, polyethylene imines, polyether amines (e.g. so-called Jeffamines® from Huntsman, such as D-230, D-400, D-2000, T-403, T-3000, T-5000 or corresponding products from BASF, such as polyetheramine D230, D400, D200, T403, T5000), polytetrahydrofuranes (e.g. PolyTHF® from BASF, such as PolyTHF® 250, 650S, 1000, 10005, 1400, 1800, 2000), polytetrahydrofurane amines (BASF product polytetrahydrofurane amine 1700), polyetherthiols, polyacrylate polyols, castor oil, the mono- or diglyceride of ricinoleic acid, monoglycerides of fat acids, chemically modified mono-, di- and/or triglycerides of fat acids, and C₁-C₂₄ alkyl fat acid esters which on average contain at least 2 OH groups per molecule, are used as H-functional starter substance. The C₁-C₂₄ alkyl fat acid esters which on average contain at least 2 OH groups per molecule are for example trade products such as Lupranol Balance® (BASF AG), Merginol® types (Hobum Oleochemicals GmbH), Sovermol® types (Cognis Deutschland GmbH & Co. KG) and Soyol® TM types (USSC Co.).

Polyvalent alcohols suitable as H-functional starter substances are for example bivalent alcohols (such as ethylene glycol, diethylene glycol, propylene glycol, dipropylene glycol, 1,3-propanediol, 1,4-butanediol, 1,4-butenediol, 1,4-butinediol, neopentyl glycol, 1,5-pentantane diol, methylpentane diols (such as 3-methyl-1,5-pentane diol), 1,6-hexane diol; 1,8-octane diol, 1,10-decane diol, 1,12-dodecane diol, bis-(hydroxymethyl)-cyclohexanes (such as 1,4-bis-(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trivalent alcohols (such as trimethylol propane, glycerin, trishydroxyethylisocyanurate, castor oil); tetravalent alcohols (such as pentaerythritol); polyalcohols (such as sorbitol, hexitol, saccharose, starch, starch hydrolysates, cellulose, cellulose hydrolysates, hydroxy-functionalised fats and oils, in particular castor oil) and all modified products of the aforementioned alcohols with different amounts of ε-caprolactone. Trivalent alcohols such as trimethylpropane, glycerin, trishydroxyethylisocyanurate and castor oil can be used in mixtures of H-functional starters as well.

The H-functional starter substances can also be selected from the substance class of the polyether polyols, in particular the ones with a molecular weight Mₙ in the range of 100 to 4000 g/mol, preferably 250 to 2000 g/mol. Polyether polyols which are composed of repeating ethylene oxide and propylene oxide units are preferred, preferably with an amount of 35 to 100% propylene oxide units, particularly preferred with an amount of 50 to 100% propylene oxide units. These can be statistical copolymers, gradient copolymers, alternating or block copolymers from ethylene oxide and propylene oxide. Suitable polyether polyols, consisting of repeating propylene oxide and/or ethylene oxide units, are for example the Desmophen®, Acclaim®, Arcol®, Baycoll®, Bayfill®, Bayflex®, Baygal®, PET® and polyether polyols from Bayer MaterialScience AG (such as Desmophen® 3600Z, Desmophen® 1900U, Acclaim® Polyol 2200, Acclaim® Polyol 4000I, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homo polyethylene oxides are for example the Pluriol® E brands from BASF SE, suitable homo polypropylene oxides are for example the Pluriol® P brands from BASF SE, suitable mixed copolymers from ethylene oxide and propylene oxide are for example the Pluronic® PE or Pluriol® RPE brands from BASF SE.

The H-functional starter substances can also be selected from the substance class of the polyester polyols, in particular the ones with a molecular weight Mₙ in the range of 200 to 4500 g/mol, preferably 400 to 2500 g/mol. Polyesters which are at least difunctional are used as polyester polyols. Polyester polyols preferably consist of alternating acid and alcohol units. For example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the stated acids and/or anhydrides are used as acid components. For example, ethanediol, 1,2-propanediol, 1,3-propanediol, 1,4-butanediol, 1,5-pentanediol, neopentyl glycol, 1,6-hexanediol, 1,4-bis-(hydroxymethyl)-cyclohexane, diethylene glycol, dipropylene glycol, trimethylolpropane, glycerin, pentaerythritol or mixtures of the stated alcohols are used as alcohol components. If bivalent or polyvalent polyether polyols are used as alcohol component, one obtains polyester ether polyols which can also serve as starter substances for the production of polyether carbonate polyols. If polyether polyols are used for the production of the polyester ether polyols, polyether polyols with a number average molecular weight Mₙ of 150 to 2000 g/mol are preferred.

Further, polycarbonate polyols (such as polycarbonate diols) can be used as H-functional starter substances, in particular such with a molecular weight Mₙ in the range of 150 to 4500 g/mol, preferably 500 to 2500, which are for example produced by the reaction of phosgene, dimethylcarbonate, diethylcarbonate or diphenylcarbonate and di- and/or polyfunctional alcohols or polyester polyols or polyether polyols. Examples of polycarbonate polyols can be found in EP-A 1359177, for example. For example, the Desmophen® C types from Bayer MaterialScience AG, e.g. Desmophen® C 1100 or Desmophen® C 2200, can be used as polycarbonate diols.

Polyethercarbonate polyols can also be used as H-functional starter substances. In particular, polyether carbonate polyols produced according to the method described hereabove are used. For this purpose, these polyether carbonate polyols used as H-functional starter substances are previously produced in a separate reaction step.

Preferred H-functional starter substances are alcohols of the general formula (VI),

HO—(CH₂)ₓ—OH (VI)

wherein x is a number from 1 to 20, preferably an even number from 2 to 20. Examples of alcohols according to formula (V) are ethylene glycol, 1,4-butane diol, 1,6-hexane diol, 1,8-octanediol, 1,10-decanediol and 1,12-dodecanediol. Further preferred H-functional starter substances are neopentyl glycol, trimethylol propane, glycerin, pentaerythritol, reaction products of the alcohols according to formula (V) with ε-caprolactone, e.g. reaction products of trimethylol propane with ε-caprolactone, reaction products of glycerin with ε-caprolactone, and reaction products of pentaerythritol with ε-caprolactone. Further, water, diethylene glycol, dipropylene glycol, castor oil, sorbitol and polyether polyols, consisting of repeating polyalkylene oxide units, are preferably used as H-functional starter substances.

One or more compounds selected from the group consisting of ethylene glycol, propylene glycol, 1,3-propanediol, 1,3-butanediol, 1,4-butanediol, 1,5-pentanediol, 2-methylpropan-1,3-diol, neopentyl glycol, 1,6-hexane diol, diethylene glycol, dipropylene glycol, glycerin, trimethylolpropane, di- and trifunctional polyether polyols, wherein the polyether polyol consists of a di- or tri-H-functional starter substance and propylene oxide or a di- or tri-H-functional starter substance, propylene oxide and ethylene oxide, are particularly preferred as H-functional starter substances. The polyether polyols preferably have a number average molecular weight Mₙ in the range of 62 to 6000 g/mol and in particular a number average molecular weight Mₙ in the range of 350 to 4500 g/mol, a molecular weight of 500 to 4000 g/mol is particularly preferred. Preferably, the polyether polyols have a functionality from ≥2 to ≤3.

In a preferred embodiment of the invention, the polyether carbonate polyol A1 can be obtained through the accumulation of carbon dioxide and alkylene oxides on H-functional starter substances using multi metal cyanide catalysts or double metal cyanide catalysts (DMC catalysts). The production of polyether carbonate polyols through the accumulation of alkylene oxides and CO₂ on H-functional starter substances using DMC catalysts is known from EP-A 0222453, WO-A 2008/013731 and EP-A 2115032, for example.

Generally, DMC catalysts are known from the state of the art for the homopolymerisation of epoxides (see, e.g., U.S. Pat. No. 3,404,109, U.S. Pat. No. 3,829,505, U.S. Pat. No. 3,941,849 and U.S. Pat. No. 5,158,922). DMC catalysts, which are e.g. described in U.S. Pat. No. 5,470,813, EP-A 700 949, EP-A 743 093, EP-A 761 708, WO-A 97/40086, WO-A 98/16310 and WO-A 00/47649, possess a very high activity in the homopolymerisation of epoxides and enable the production of polyether polyols and/or polyether carbonate polyols at very low catalyst concentrations (25 ppm or less). A typical example are the highly active DMC catalysts described in EP-A 700 949, which, apart from a double metal cyanide compound (e.g. zinc hexacyanocobaltate(III)) and an organic complex ligand (e.g. t-butanol), also contain a polyether with a number average molecular weight Mₙ greater than 500 g/mol.

The DMC catalyst is mostly used in an amount of ≤1 weight %, preferably in an amount of ≤0.5 weight %, particularly preferably in an amount of ≤500 ppm and in particular in an amount of ≤300 ppm, respectively based on the weight of the polyether carbonate polyol.

In a preferred embodiment of the invention, the polyether carbonate polyol A1 has a content of carbonate groups (“units derived from carbon dioxide”), calculated as CO₂, of ≥2.0 and ≤30.0 weight %, preferably of ≥5.0 and ≤28.0 weight %, particularly preferably of ≥10.0 and ≤26.0 weight % and still more preferred of ≥15.0 and ≤25.0%.

In a further embodiment of the invention, the one or the more polyether carbonate polyols according to A1 have a hydroxyl number of ≥20 mg KOH/g to ≤300 mg KOH/g and can be obtained through copolymerisation of ≥2.0 weight % to ≤30.0 weight % of carbon dioxide and ≥70 weight % to ≤98 weight % of propylene oxide in the presence of a hydroxy-functional starter molecule such as trimethylolpropane and/or glycerin and/or propylene glycol and/or sorbitol. The hydroxyl number can be determined according to DIN 53240.

According to a further preferred embodiment of the invention, a polyether carbonate polyol A1 is used which has blocks according to formula (I) with a ratio e/f of 2:1 to 1:20, in particular of 1.5:1 to 1:10.

Within the framework of the invention, it is preferred that component A contains≥55 to ≤100 weight parts of the polyether carbonate polyol A1 and ≤45 to ≥0 weight parts of the polyether polyol A2, in particular ≥60 to ≤100 weight parts of the polyether carbonate polyol A1 and ≤40 to ≥0 weight parts of the polyether polyol A2.

In a further embodiment of the invention, 100 weight parts of component A1, 0 weight parts of component A2 and, apart from A1, no further organic polyols are used.

Within the framework of the present invention, it is particularly preferred that the polyether carbonate polyol A1 has an average OH-functionality of 2.3 to 3.5, in particular of 2.5 to 3.3, preferably of 2.7 to 3.1, 2.8 to 3.0 being particularly preferred.

### Component A2

Component A2 comprises polyether polyols with a hydroxyl number according to DIN 53240 of ≥20 mg KOH/g to ≤250 mg KOH/g, preferably of ≥20 mg KOH/g to ≤112 mg KOH/g, and particularly preferably of ≥20 mg KOH/g to ≤80 mg KOH/g and is free from carbonate units. The compounds according to A2 can be produced by catalytic addition of one or more alkylene oxides to H-functional starter compounds.

Alkylene oxides with 2 to 24 carbon atoms can be used as alkylene oxides (epoxides). The alkenyl oxides with 2 to 24 carbon atoms are for example one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-penteneoxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrole oxide, methylstyrole oxide, pinene oxide, one or more times epoxy-enhanced fats as mono-, di- and triglycerides, epoxy-enhanced fat acids, C₁-C₂₄ esters of epoxy-enhanced fat acids, epichlorohydrin, glycidol, and derivates of the glycidol, such as methylglycidyl ethers, ethylglycidyl ethers, 2-ethylhexylglycidyl ethers, allylglycidyl ethers, glycidylmethacrylate and epoxy-functional alkoxy silanes such as 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preferably, ethylene oxide and/or propylene oxide and/or 1,2 butylene oxide are used as alkylene oxides. The use of excess propylene oxide and/or 1,2-butylene oxide is particularly preferred. The alkenyl oxides can be added to the reaction mixture separately, in a mixture or subsequently. It can be statistical or block copolymers. If the alkylene oxides are dosed in a subsequent manner, the produced products (polyether polyols) contain polyether chains with block structures.

The H-functional starter compounds have functionalities from ≥2 to ≤6 and are preferably hydroxy functional (OH functional). Examples of hydrofunctional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerin, trimethylolpropane, triethanoleamin, pentaerythritol, sorbitol, saccharose, hydrochinone, brenzcatechin, resorcin, bisphenol F, bisphenol A, 1,3,5-trihydroxybenzol, methylol group-containing condensates of formaldehyde and phenol or melamin or urea. 1,2-propylene glycol and/or glycerin and/or trimethylol propane and/or sorbitol are preferably used as starter compound.

The polyether polyols according to A2 preferably have a content of ≥0 to ≤40 weight %, particularly preferably ≥0 to ≤25 weight % of ethylene oxide.

### Component A3

0.5 to 25 weight parts, preferably 1.0 to 15 weight parts, particularly preferably 1.5 to 10 weight parts, based on the sum of the weight parts of components A1 and A2, water and/or physical propellants, are used as component A3. For example, carbon dioxide and/or highly volatile organic substances are used as propellants. Preferably, water is used as component A3.

### Component A4

Antioxidants which can be used for the production of polyurethane soft foams are generally known to the person skilled in the art. Such compounds are for example described in EP-A 1874853, G. Oertel (editor): “Kunststoff-Handbuch”, volume VII, Carl-Hanser-Verlag, Munich, Vienna 1993, chapter 3.4.8 or in Ullmanns' Encyclopedia of Industrial Chemistry Peter P. Klemchuck, 2012, Vol. 4, p. 162 et seq., Wiley VCH.

According to a preferred embodiment of the invention, component A4 comprises an antioxidant A4.1 which is free from compounds with amino groups and an antioxidant A4.2 which comprises at least one compound with one or more amino groups.

In a further advantageous embodiment of the invention, component A4, as component A4.1, contains 0.02-5.0 weight parts, based on the sum of the weight parts of components A1 and A2, of an antioxidant which is free from amino groups and, as component A4.2, 0.02-5.0 weight parts, based on the sum of the weight parts of components A1 and A2, of an antioxidant which comprises at least one compound with one or more amino groups, wherein the total content of component A4 is in particular 0.04-10.0 weight parts, based on the sum of the weights parts of components A1 and A2.

In the present invention, the antioxidant A4.1 and A4.2 can also be contained in a respective amount of 0.05-1.5 weight parts, based on the sum of the weight parts of components A1 and A2, wherein the total content of component A4 is in particular 0.1-3.0 weight parts, based on the sum of the weight parts of components A1 and A2.

Antioxidants A4.1 which are free from amino groups comprise compounds, containing
i) phenol derivatives
ii) lactone, in particular benzofuran-2-on-derivatives
iii) phosphorus derivatives,
and any mixtures of these compounds.

Compounds containing phenol derivatives i) are for example 2,6-di-(t-butyl)-p-cresol (BHT), tetrakis[methylene(3,5-di-t-butyl-4-hydroxyhydrocinnamat)]methane, 2,2′-methylenebis-(4-methyl-6-t-butylphenol), 2,6-di-t-butyl-4-methylphenol, N,N′-1,6-hexamethylene-bis-3-(3,5-di-t-butyl-4-hydroxyphenyl)propionamide, alkyl-3-(3,5-di-t-butyl-4-hydroxyphenylpropionate), wherein alkyl comprises C1 to C24 carbon atoms, preferably C1 to C20 carbon atoms, particularly preferably C1 to C18 carbon atoms, ethylene-(bisoxyethylene)bis-(3,(5-t-butylhydroxy-4-tolyl)-propionate 4,4′-butylidenbis-(6-t-butyl-3-methylphenol) and/or tocopherols such as α-tocopherol, β-tocopherol, γ-tocopherol, δ-tocopherol and their mixtures (vitamin E), preferred are 2,6-di-(t-butyl)-p-cresol (BHT), tetrakis[methylene(3,5-di-t-butyl-4-hydroxyhydrocinnamat)]methane, alkyl-3-(3,5-di-t-butyl-4-hydroxyphenylpropionate), wherein alkyl comprises C1 to C24 carbon atoms, preferably C1 to C20 carbon atoms, particularly preferably C1 to C18 carbon atoms, octadecyl-3-(3,5-di-t-butyl-4-hydroxyphenylpropionate), α-tocopherol, β-tocopherol, γ-tocopherol and/or δ-tocopherol.

Amine-free lactones ii), in particular benzofuranones, are for example described in EP-A 1291384 and DE-A 19618786. Preferred benzofuranones are for example 5,7-di-t-butyl-3-phenyl-benzofurane-2-one, 5,7-di-t-butyl-3-(3,4-dimethylphenyl)-benzofurane-2-one, 5,7-di-t-butyl-3-(2,3-dimethylphenyl)-benzofurane-2-one and/or 5-t-octyl-3-(2-acetyl-5-t-octylphenyl)-benzofurane-2-one.

Antioxidants iii) are for example phosphites and phosphonites. They are for example described in EP-A 905180 and EP-A 1874853, such as triphenylphosphite, diphenylalkylphosphite, phenyldialkylphosphite, tris(nonylphenyl)phosphite, trilaurylphosphite, trioctadecylphosphite, distearylpentaerythritol-diphosphite, tris(2,4-di-t-butylphenyl)phosphite, diisodecylpentaerythritoldiphosphite, bis(2,4-di-t-butylphenyl)pentaerythritoldiphosphite, bis(2,6-di-t-butyl-4-methylphenyl)-pentaerythritol-diphosphite, bisisodecyloxypenta-erythritoldiphosphite, bis(2,4-di-t-butyl-6-methylphenyl)penta-erythritoldiphosphite, bis(2,4,6-tri-t-butylphenyl)pentaerythritoldiphosphite, tristearylsorbitol-triphosphite, tetrakis(2,4-di-t-butylphenyl)4,4′-biphenylendiphosphonite, 6-isooctyloxy-2,4,8,10-tetra-t-butyl-12H-dibenzo[d,g]-1,3,2-dioxaphosphocine, 6-fluoro-2,4,8,10-tetra-t-butyl-12-methyldibenzo[d,g]-1,3,2-dioxaphosphocine, bis(2,4-di-t-butyl-6-methylphenyl)methyl-phosphite and/or bis(2,4-di-t-butyl-6-methylphenyl)ethylphosphite.

Antioxidants A4.2, which comprise at least one compound with one or more amino groups, are generally secondary amines of the formula (VII)

HNR1R2 (VII),

wherein R1 is C1-C18 alkyl, phenyl-C1-C4-alkyl, C-5-C12-cycloalkyl, phenyl, naphthyl, phenyl or naphthyl, each of which being substituted by C1-C12 alkyl or C1-C12 alkoxy or benzyl or α,α-dimethylbenzyl, and R2 is phenyl, naphthyl, phenyl or naphthyl, each of which being substituted by C1-C12 alkyl or C1-C12 alkoxy or benzyl or α,α-dimethylbenzyl.

Suitable antioxidants A4.2 are for example N,N′-di-isopropyl-p-phenylenediamine, N,N′-di-sec-butyl-p-phenylenediamine, N, N′-bis(1,4-dimethyloentyl)-p-phenylenediamine, N, N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluolsulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-t-octylphenyl)-1-naphthylamine, N-phenyl-2-naphthylamine, octylated diphenylamine, for example p,p′-di-t-octyldiphenylamine, 4-n-butylaminophenole, 4-butyrylaminophenole, 4-nonanoylaminophenole, 4-dodecanoylaminophenole, 4-octadecanoylaminophenole, bis(4-methoxyphenyl)amine, 2,6-di-t-butyl-4-dimethylaminomethylphenole, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, t-octylated N-phenyl-1-naphthylamine, a mixture of mono- and dialkylated t-butyl/t-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated t-butyldiphenylamines, 2,3-dihydro-3,3-dimethyl-4H-1,4-benzothiazine, phenothiazine, a mixture of mono- and dialkylated t-butyl/t-octylphenothiazines, a mixture of mono- and dialkylated t-octyl-phenothiazines, N-allylphenothiazine and/or N,N,N′,N′-tetraphenyl-1,4-diaminobut-2-ene, preferably a mixture of mono- and dialkylated t-butyl/t-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated t-butyldiphenylamines.

In a preferred embodiment of the present invention, the antioxidant A4.1, which is free from amino groups, comprises compounds containing
i) phenol derivatives,
ii) lactones
iii) phosphorus derivatives,
and any mixtures of these compounds, and
   the antioxidant A4.2 comprises at least one compound with one or more secondary amino groups.

It can further be provided that the antioxidant A4.1 comprises at least one phenol derivative i) and the antioxidant A4.2 comprises at least one compound of the formula

HNR1R2 (VII),

wherein R1 is C1-C18 alkyl, phenyl-C1-C4-alkyl, C5-C12-cycloalkyl, phenyl, naphthyl, phenyl or naphthyl, each of which being substituted by C1-C12 alkyl or C1-C12 alkoxy or benzyl or α,α-dimethylbenzyl, and R2 is phenyl, naphthyl, phenyl or naphthyl, each of which being substituted by C1-C12 alkyl or C1-C12 alkoxy or benzyl or α,α-dimethylbenzyl.

In a further embodiment, antioxidant A4.1 is used in an amount of 0.02-3.0 weight parts, preferably 0.04-2.0 weight parts, particularly preferably 0.05-1.5 weight parts, based on the sum of the weight parts of components A1 and A2, and antioxidant A4.2 is used in an amount of 0.02-3.0 weight parts, preferably 0.04-2.0 weight parts, particularly preferably 0.05-1.5 weight parts, based on the sum of the weight parts of components A1 and A2.

In a further embodiment the method of the invention is carried out in the presence of
A4.1 0.02-3.0 weight parts, preferably 0.04-2.0 weight parts, particularly preferably 0.05-1.5 weight parts, based on the sum of the weight parts of components A1 and A2, at least one compound selected from the group consisting of 2,6-di-(t-butyl)-p-cresol (BHT), tetrakis[methylene(3,5-di-t-butyl-4-hydroxyhydrocinnamat)]methane, 2,2′-methylenebis-(4-methyl-6-t-butylphenole), 2,6-di-t-butyl-4-methylphenol, N,N′-1,6-hexamethylene-bis-3-(3,5-di-t-butyl-4-hydroxyphenyl)propionamide, alkyl-3-(3,5-di-t-butyl-4-hydroxyphenylpropionate), wherein alkyl comprises C1 to C24 carbon atoms, preferably C1 to C20 carbon atoms, particularly preferably C1 to C18 carbon atoms, ethylene-(bisoxyethylene)bis-(3,(5-t-butylhydroxy-4-tolyl)-propionate 4,4′-butylidenebis-(6-t-butyl-3-methylphenole) and/or tocopherols such as α-tocopherol, β-tocopherol, γ-tocopherol, δ-tocopherol and their mixtures (vitamin E),
and
A4.2 0.02-3.0 weight parts, preferably 0.04-2.0 weight parts, particularly preferably 0.05-1.5 weight parts, based on the sum of the weight parts of components A1 and A2, at least one compound selected from the group consisting of N,N′-di-isopropyl-p-phenylenediamine, N,N′-di-sec-butyl-p-phenylenediamine, N, N′-bis(1,4-dimethylpentyl)-p-phenylenediamine, N, N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluolsulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-t-octylphenyl)-1-naphthylamine, N-phenyl-2-naphthylamine, octylated diphenylamine, for example p,p′-di-t-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-t-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, t-octylated N-phenyl-1-naphthylamine, a mixture of mono- and dialkylated t-butyl/t-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated t-butyldiphenylamines, 2,3-dihydro-3,3-dimethyl-4H-1,4-benzothiazine, phenothiazine, a mixture of mono- and dialkylated t-butyl/t-octylphenothiazines, a mixture of mono- and dialkylated t-octyl-phenothiazines, N-allylphenothiazine and/or N,N,N′,N′-tetraphenyl-1,4-diaminobut-2-ene.

In a further embodiment the method of the invention is carried out in the presence of
A4.1 0.02-3.0 weight parts, preferably 0.04-2.0 weight parts, particularly preferably 0.05-1.5 weight parts, based on the sum of the weight parts of components A1 and A2, at least one compound selected from the group consisting of 2,6-di-(t-butyl)-p-cresole (BHT), tetrakis[methylene(3,5-di-t-butyl-4-hydroxyhydrocinnamate)]-methane, alkyl-3-(3,5-di-t-butyl-4-hydroxyphenylpropionate), wherein alkyl comprises C1 to C18 carbon atoms, octadecyl-3-(3,5-di-t-butyl-4-hydroxyphenylpropionate), α-tocopherol, β-tocopherol, γ-tocopherol and/or δ-tocopherol,
and
A4.2 0.02-3.0 weight parts, preferably 0.04-2.0 weight parts, particularly preferably 0.05-1.5 weight parts, based on the sum of the weight parts of components A1 and A2, at least one compound selected from the group consisting of mono- and dialkylated t-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated t-butyldiphenylamines.

### Component A5

As component A5, 0 to 10 weight parts of adjuvants and additives are used, in particular 0.1 to 8.0 weight parts, preferably 0.1 to 7.5 weight parts, particularly preferably 0.15 to 7.0 weight parts, respectively based on the sum of the weight parts of components A1 and A2. For example, the following components can be used separately or in any combination as adjuvants or additives according to the method of the invention:
a) catalysts,
b) surface-active additives such as emulsifiers and foam stabilisers, in particular the ones with a low emission, such as products of the Tegostab® LF series,
c) Additives such as reaction retarders (e.g. agents with an acidic reaction such as hydrochloric acid or organic acid halides), cell regulators (such as paraffins or fatty alcohols or dimethylpolysiloxanes), pigments, colouring agents, solid flame retardants (such as melamine and/or ammoniumpolyphosphate), liquid flame retardants (e.g. halogenated, such as tris(2-chloropropyl)phosphate or halogen-free, e.g. on the basis of oligomer phosphates as described e.g. in EP 2687534 and U.S. Pat. No. 4,382,042), further stabilisers against ageing and weather conditions, plasticisers, substances with a fungiastic and bacteriostatic action, fillers (such as barium sulphate, kieselgur, soot chalk or whiting) and separating agents.

These adjuvants and additives which are to be used optionally are for example described in EP-A 0 000 389, pages 18-21. Further examples of adjuvants and additives to be optionally used according to the invention as well as details concerning the use and action of these adjuvants and additives are described in the Kunststoff-Handbuch, volume VII, published by G. Oertel, Carl-Hanser-Verlag, Munich, 3rd edition, 1993, e.g. on pages 104-127.

Preferably, aliphatic tertiary amines (such as trimethylamine, triethylamine, tetramethylbutanediamine), cycloaliphatic tertiary amines (such as 1,4-diaza(2,2,2)bicyclooctane), aliphatic aminoethers (such as dimethylaminoethylethers and N,N,N-trimethyl-N-hydroxy ethyl-bisaminoethylethers), cycloaliphatic aminoethers (such as N-ethylmorpholine), aliphatic amidines, cycloaliphatic amidines, urea, derivates of the urea (such as aminoalkyl ureas, see for example EP-A 0 176 013, in particular (3-dimethylaminopropylamine) urea) and tin catalysts (such as dibutyl tin oxide, dibutyl tin dilaurate, tin(II)-ethylhexanoate, tin ricinoleate) are used as catalysts.

### Component B

Suitable di- and/or polyisocyanates are aliphatic, cycloaliphatic, araliphatic, aromatic and heterocyclic polyisocyanates as described e.g. by W. Siefken in Justus Liebigs Annalen der Chemie, 562, pages 75 to 136, for example the ones with the formula (VIII)

Q(NCO)ₙ, (VIII)

wherein
n=2-4, preferably 2-3,
and
Q is an aliphatic hydrocarbon residue with 2-18 carbon atoms, preferably 6-10 carbon atoms, a cycloaliphatic hydrocarbon residue with 4-15 carbon atoms, preferably 6-13 carbon atoms or an araliphatic hydrocarbon residue with 8-15 carbon atoms, preferably 8-13 carbon atoms.

For example, these are polyisocyanates as described in EP-A 0 007 502, pages 7-8. Preferably, generally the polyisocyanates which are technically easily accessible are used, for example 2,4- and 2,6-toluylenediisocyanate, as well as any mixtures of these isomers (“TDI”); polyphenylpolymethylenepolyisocyanates, as produced by aniline formaldehyde condensation and subsequent phosgenation (“raw MDI”) and polyisocyanates having carbodiimide groups, urethane groups, allophanate groups, isocyanurate groups, urea groups or biuret groups (“modified polyisocyanates”), in particular such modified polyisocyanates which are derived from 2,4- and/or 2,6-toluylenediisocyanate or from 4,4′- and/or 2,4′-diphenylmethanediisocyanate. Preferably, one or more compounds selected from the group consisting of 2,4- and 2,6-toluylenediisocyanate, 4,4′- and 2,4′- and 2,2′-diphenylmethanediisocyanate and polyphenylpolymethylenepolyisocyanate (“multicore MDI”) are used as polyisocyanate.

In a further embodiment of the present invention, the isocyanate component B comprises a toluylenediisocyanate isomer mixture of 55 to 90 weight % of 2,4- and 10 to 45 weight % of 2,6-TDI.

In a further embodiment of the present invention, the index is ≥70 to ≤130, preferably ≥85 to ≤125, ≥90 to ≤120 being particularly preferred. The index indicates the percentage ratio of the amount of isocyanate actually used to the stoichiometric amount, i.e. the amount of isocyanate groups (NCO) calculated for the reaction of the OH equivalents:

index=[used amount of isocyanate):(calculated amount of isocyanate)·100 (IX)

The polyurethane foams to be obtained according to the invention, are for example used as: furniture upholstery, textile inlays, mattresses, car seats, headrests, armrests, sponges, foam foils for use in automotive parts such as roof liners, door claddings, seat covers and for construction components.

The polyurethane hard foams and polyurethane soft foams produced according to the invention typically show low discolouration tendencies during the storage in the air and also under the influence of light, in particular UV light.

In the following, the present invention will be illustrated by way of exemplary embodiments.

### Examples

Used chemicals:

Arcol Polyol 1108: trifunctional polyether polyol on the basis of glycerin with hydroxyl number 48 mg KOH/g, obtained by copolymerisation of 12 weight % of ethylene dioxide with 88 weight % of propylene oxide.

CO₂ Polyol Type 10C: trifunctional polyol on the basis of glycerin with hydroxyl number 50 mg KOH/g, obtained by copolymerisation of 20.5 weight % of carbon dioxide with 79.5 weight % of propylene oxide.

Tegostab BF 2370: Siloxane-based foam stabiliser Tegostab® BF2370, from Evonik Goldschmidt.

Desmophen 41WB01: trifunctional polyol on the basis of glycerin with OHZ 37, obtained by copolymerisation of 62 weight % of EO and 20 weight % of PO, 83% of prim. OH groups.

Addocat 108E: Catalyst bis-(2-dimethylamino-ethyl)-ether in dipropyleneglycol, to be obtained as Addocat® 108, Rheinchemie.

Dabco T-9: Tin(II)-ethylexanoate, to be obtained as Dabco® T-9, Air Products

Desmodur T80: Mixture of 80 weight % of 2,4- and 20 weight % of 2,6-toluylendiisocyanate.

### Methods:

### Determination of the Colour Angle:

The colour angle is determined such that the respective sample body is photographed lying on a white sheet of paper with the help of a digital camera (Sony DSC-R1), a white balance against the white sheet of paper is carried out and then the colour tone is determined as the colour angle from the HSI model and from the photograph with the help of an image evaluation software (AnalySIS). The colour shade is determined as colour angle H on the colour wheel (0°=red, 120°=green, 240°=blue) and specifies the dominant wavelength of the colour, with the exception of the area between violet-blue and red (240° and 360°) where it indicates a position on the purple line. This measurement is respectively carried out with a colour-stable polyurethane foam produced according to the invention following the above-mentioned ageing and a reference polyurethane foam aged in the same manner. The determined colour angles of the colour-stable polyurethane foam and the reference polyurethane foam are subtracted from one another and thus provide the shift of the colour angle which is at least 5° less according to the invention for the colour-stable polyurethane foam. The measured foams basically have a green colour, so that the absolute values of the colour angles are in the range of about 120°.

Polyurethane foams were produced according to the formulas indicated in the following table 1. The proportions of the components are stated in weight parts. The bulk density and the compression hardness were determined according to DIN EN ISO 3386-1.

The tensile strength and tensile strength were determined according to DIN EN ISO 1798.

The compression set was determined according to DIN EN ISO 1856.

TABLE 1
Used compositions

| | | V1 | V2 | V3 | V4 |
|---|---|---|---|---|---|
| | OHZ/ | (inven- | (inven- | (compar- | (compar- |
| Components | Water | tion) | tion) | ison) | ison) |
| Arcol Polyol | 48/0.04 | 30.00 | 30.00 | 100.00 | 100.00 |
| 1108 | | | | | |
| CO2 Polyol | 55 | 70.00 | 70.00 | | |
| Type10C | | | | | |
| Water (added) | 6228 | 3.80 | 3.80 | 3.80 | 3.80 |
| Tegostab | 0 | 1.20 | 1.20 | 1.20 | 1.20 |
| BF2370 | | | | | |
| Desmophen | 37 | | 5.00 | | 5.00 |
| 41WB01 | | | | | |
| ADDOCAT | 251 | 0.12 | 0.12 | 0.12 | 0.12 |
| 108 E | | | | | |
| DABCO T-9 | 0 | 0.18 | 0.18 | 0.18 | 0.18 |
| Sum | g | 105.30 | 110.30 | 105.30 | 110.30 |
| | % NCO | | | | |
| Desmodur T80 | 48.30 | 46.73 | 47.03 | 45.94 | 46.24 |
| Total sum | g | 152.03 | 157.33 | 151.24 | 156.54 |
| Index | | 104.0 | 104.0 | 104.0 | 104.0 |

Table 1 shows that the tests V1 and V3 as well as V2 and V4 each compare a polyurethane foam according to the invention and a corresponding reference foam.

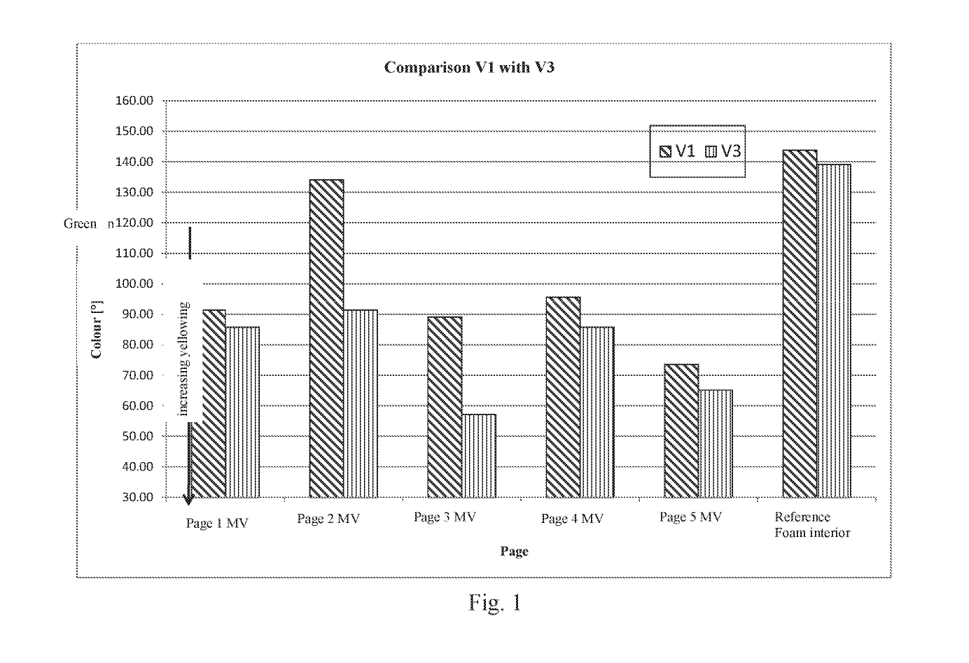

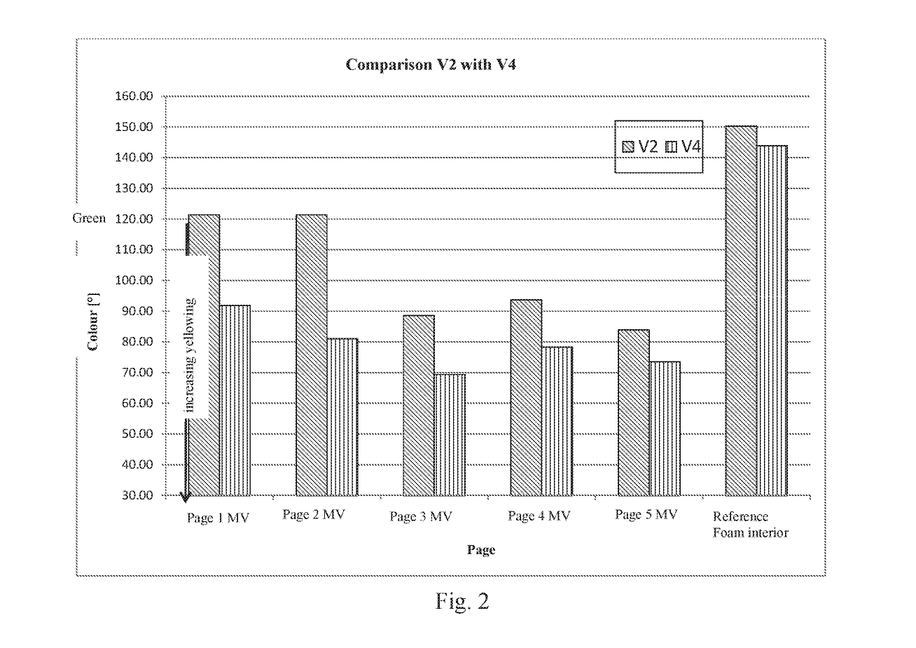

All foams V1 to V4 were produced immediately one after the other. After the foams have been cooled and completely reacted, rectangular sample bodies with edge lengths H×W×D of 4×10×10 cm were cut. The produced sample bodies were subsequently stored on one of their flat sides over a period of 90 days at 20° C. and 40% rel. humidity in a laboratory under daylight conditions. The flat sides are referred to as side 1 (top) and side 2 (bottom). Sides 3 to 5 correspond to three side surfaces. The respective fourth side surface was not measured as the samples were labelled thereon. The sample V2 according to the invention was turned from one flat side to the other in regular intervals, so that the two flat sides were exposed to daylight for about the same period. The samples V1, V3 and V4 were not turned around. The blank values were determined after storage by cutting the centre of the sample bodies after measuring the outer sides and determining the colour value in the centre of the cut surface. As the centre of the sample body was neither exposed to light nor to direct air, this value can be used to compare to what extent the colour of the foams has changed since their production. Subsequently, the sample bodies were subjected to the above-mentioned determination of the colour angle. The results are summarised in the following tables 2 and 3 and in the FIGS. 1 and 2.

TABLE 2
Results of the colour angle measurements.

| Page: | V1 [°] | V2 [°] | V3 [°] | V4 [°] |
|---|---|---|---|---|
| 1 | 91.41 | 121.41 | 85.78 | 91.88 |
| 2 | 134.06 | 121.41 | 91.41 | 81.09 |
| 3 | 89.06 | 88.59 | 57.19 | 69.38 |
| 4 | 95.63 | 93.75 | 85.78 | 78.28 |
| 5 | 73.59 | 83.91 | 65.16 | 73.59 |
| Blank value | 143.81 | 150.28 | 139.09 | 143.96 |

TABLE 3
Determination of the shift of the colour angle as compared between the
samples according to the invention and the comparative samples.

| Page | V3 − V1 [°] | V4 − V2 [°] |
|---|---|---|
| 1 | −5.63 | −29.53 |
| 2 | −42.66 | −40.31 |
| 3 | −31.88 | −19.22 |
| 4 | −9.84 | −15.47 |
| 5 | −8.44 | −10.31 |

In the colour angles, lower values show an increasing colour change of the foams, mainly yellowing, i.e. a shift from greenish (120°) to yellowish (90°) colour tones. The freshly produced foams generally have the same greenish starting colour, i.e. they are in the range of about 100 to 120°.

The results show that by the use of polyether carbonate polyols according to the invention for the production of polyurethane foams, a significant improvement of the colour stability can be obtained compared to standard polyurethane foams which are only based on polyether polyols. On each sample surface, the colour angle shift difference to the direct comparative example is more than 5°, sometimes even almost 43°. In particular at the bottom 2 of sample 1, the colour shift is significantly lower than at the bottom 2 of the direct comparative sample 3. Sample 2 also shows that by regularly turning the sample body around, the top 1 and the bottom 2 in total experienced a lower and also identical colour shift which is even significantly lower than the bottom 2 of the direct comparative sample 4.

1. A process for the production of colour-stable polyurethane foams comprising reacting a di- or polyisocyanate component with an isocyanate-reactive component comprising component A a polyol component which comprises≥50 to ≤100 weight % based on the polyol component of at least one polyether carbonate polyol A1 with a hydroxyl number according DIN 53240 from ≥20 mg KOH/g to ≤300 mg KOH/g.

2. The process according to claim 1, wherein component A comprises
A1≥50 to ≤100 parts by weight of at least one polyether carbonate polyol with a hydroxyl number from ≥20 mg KOH/g to ≤300 mg KOH/g according to DIN 53240,
A2≤50 to ≥0 parts by weight of at least one polyether polyol with a hydroxyl number from ≥20 mg KOH/g to ≤250 mg KOH/g according to DIN 53240, wherein the polyether polyol is free from carbonate units,
A3 0.5 to 25 parts by weight, based on the sum of the parts by weight of components A1 and A2, water and/or physical propellants,
A4 0 to 10 parts by weight, based on the sum of the parts by weight of components A1 and A2, at least one antioxidant,
A5 0 to 10 parts by weight, based on the sum of the parts by weight of components A1 and A2, adjuvants and additives,
wherein the sum of the parts by weight of components A1+A2 is 100 parts by weight in the composition.

3. The process according to claim 2, wherein component A is reacted with a component B comprising one or more di- and/or polyisocyanates, at an isocyanate index of 70 to 130.

4. The process according to claim 2, wherein component A comprises≥55 to ≤100 parts by weight of the polyether carbonate polyol A1 and ≤45 to ≥0 parts by weight of the polyether polyol A2.

5. The process according to claim 2, wherein component A comprises 100 parts by weight of A1, 0 parts by weight of A2 and is free of other organic polyols.

6. The process according to claim 2, wherein said polyether carbonate polyol A1 has a hydroxyl number according to DIN 53240 from ≥24 mg KOH/g to ≤280 mg KOH/g.

7. The process according to claim 2, wherein said polyether carbonate polyol A1 has an average OH functionality of 2.3 to 3.5.

8. The process according to claim 2, wherein said polyether carbonate polyol A1 can be obtained by copolymerisation of ≥2 weight % to ≤30 weight % of carbon dioxide and ≥70 weight % to ≤98 weight % of one or more alkylene oxides in the presence of one or more H-functional starter molecules with an average functionality of ≥1 to ≤6, wherein said polyether carbonate polyol A1 can be obtained in the presence of a multi metal cyanide catalyst or a double metal cyanide catalyst.

9. The process according to claim 2, wherein said polyether carbonate polyol A1 can be obtained from one or more alkylene oxides comprising ethylene oxide and/or propylene oxide.

10. The process according to claim 2, wherein said polyether carbonate polyol A1 comprises blocks e and f which correspond to formula (I) in which the ratio e/f ranges from 2:1 to 1:20.

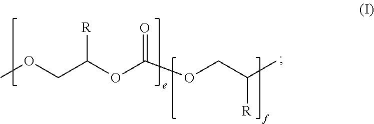

11. The process according to claim 2, wherein component A4 comprises component A4.1 comprising 0.02-5.0 parts by weight, based on the sum of the parts by weight of components A1 and A2, of an antioxidant which is free from amino groups, and component A4.2 comprising 0.02-5.0 parts by weight, based on the sum of the parts by weight of components A1 and A2, of an antioxidant which comprises at least one compound with one or more amino groups, wherein the total content of component A4 is 0.04-10.0 parts by weight, based on the sum of the parts by weight of components A1 and A2.

12. The process according to claim 11, wherein said antioxidant A4.1 is selected from the group consisting of i) phenol derivatives, ii) lactones, iii) phosphorus derivatives and iv) mixtures of these compounds, and said antioxidant A4.2 comprises at least one compound with one or more secondary amino groups.

13. The process according to claim 2, wherein component B comprises 2,4-toluene diisocyanate, 2,6-toluene diisocyanate, 4,4′-diphenylmethanediisocyanate, 2,4′-diphenylmethanediisocyanate, 2,2′-diphenylmethanediisocyanate, polyphenylpolymethylenepolyisocyanate or mixtures thereof.

14. The process according to claim 2, wherein the resultant colour-stable polyurethane foam which is in the form of a rectangular or square sample body has, in the center of at least one of its flat sides and after a storage time of 90 days at 20° C. and a relative humidity of 40%, a shift of the colour angle in the HSI model which is at least 5° less than the shift of the colour angle of a reference polyurethane foam which is produced and stored in the same manner as the colour-stable polyurethane foam, in which the only difference between the reference polyurethane foam and the colour-stable polyurethane foam is that instead of the polyether carbonate polyol A1, an essentially identical amount of a polyether polyol without carbonate units, but having essentially the same hydroxyl number according to DIN 53240 is used for the production of the reference polyurethane foam.

15. An article comprising the colour-stable polyurethane foam produced according to claim 2, in furniture, textile, bedding, automotive and/or construction industries.
